(19) United States
(12) Patent Application Publication
(10) Pub. No.: US 2018/0162251 A1
(43) Pub. Date: Jun. 14, 2018

(54) PIVOTABLE REST ARRANGEMENT AND METHOD FOR PRODUCING SAME

(71) Applicants: Hartmut BOHLKE, Wuppertal (DE); Wolfgang SITZLER, Wuppertal (DE); Bogdan TUTELEA, Leichlingen (DE); Andreas GÖBBELS, Kürten (DE); Tanja PINK, Wuppertal (DE); Jan BODDENBERG, Köln (DE)

(72) Inventors: Hartmut BOHLKE, Wuppertal (DE); Wolfgang SITZLER, Wuppertal (DE); Bogdan TUTELEA, Leichlingen (DE); Andreas GÖBBELS, Kürten (DE); Tanja PINK, Wuppertal (DE); Jan BODDENBERG, Köln (DE)

(21) Appl. No.: 15/838,816

(22) Filed: Dec. 12, 2017

(30) Foreign Application Priority Data
Dec. 14, 2016 (DE) 10 2016 224 997.5

(51) Int. Cl. B60N 2/75; B60N 3/10

(52) U.S. Cl. CPC B60N 2/757; B29C 44/1266; B60N 2/793; B60N 3/102

(57) ABSTRACT

A pivotable rest arrangement for a vehicle interior, and method for producing the rest arrangement. The rest arrangement has a rest body with a cover and a receptacle for a housing shell which is configured for holding at least one drinking vessel, the housing shell having an encircling collar. The collar in the mounted state covers the cover in the region of an edge of the receptacle, and the collar is connected to the cover in a form-fitting, integrally bonded or force-fitting manner.

### CROSS-REFERENCE TO RELATED APPLICATIONS

This claims priority from German Application No. DE 10 2016 224 997.5, filed Dec. 14, 2016, the disclosure of which is hereby incorporated by reference in its entirety.

### FIELD OF THE INVENTION

The invention relates to a pivotable rest arrangement for a vehicle interior, with a rest body which has a cover and a receptacle for a housing shell which is configured for holding at least one drinking vessel, the housing shell having an encircling collar. The invention also relates to a method for producing such a rest arrangement.

### BACKGROUND OF THE INVENTION

DE 10 2013 204 000 A1 discloses a pivotable rest arrangement for a vehicle interior of a passenger vehicle. The rest arrangement is part of a backrest of a rear seat bench of the passenger vehicle. The rest arrangement has a rest body which is provided with padding in the form of a foam body. The rest body is stabilized by a dimensionally stable frame structure which is mounted pivotably by means of a pivot bearing on the vehicle side in the region of the backrest arrangement. The rest body is provided with a receptacle into which a housing shell is inserted which is provided for receiving at least one drinking vessel. The housing shell has a cover frame which is provided in the region of an upper side of the rest body with respect to an approximately horizontally forwardly pivoted arm rest position of the rest body. The housing shell has a base region which is held in an elastically yielding manner in relation to a leaning surface of the rest body, said leaning surface being provided in the region of a lower side opposite the cover frame.

### SUMMARY OF THE INVENTION

It is the object of the invention to provide a pivotable rest arrangement and a method for producing same, of the type mentioned in each case at the beginning, which permit a visually attractive, cost-effective and compact design.

This object is achieved for the pivotable rest arrangement in that the collar in the mounted state covers the cover in the region of an edge of the receptacle, and in that the collar is connected to the cover in a form-fitting, integrally bonded or force-fitting manner. By means of the solution according to the invention it is ensured that the cover in the region of the upper side of the rest body, in which the collar is positioned, does not crease and is connected fixedly to the collar. The housing shell itself is held fixedly in the receptacle of the rest body, as a result of which a secure connection is obtained between the housing shell and the rest body. The solution according to the invention is suitable in a particularly advantageous manner for a rest arrangement in the form of a central arm rest which is mounted pivotably on the vehicle side in the region of a rear seat bench. The rear seat bench is part of a vehicle interior of a passenger vehicle. The rest arrangement according to the invention is advantageously mounted pivotably between an upwardly pivoted inoperative position, in which the rest arrangement is integrated in a backrest of the rear seat bench, and a forwardly and downwardly pivoted functional position, in which an open side of the receptacle of the rest body is oriented upward such that the collar of the housing shell is positioned in the region of the upper side of the rest body. This pivot position forms an arm rest position, in which a person sitting on the rear seat bench can support their arm on the upper side of the rest body. Owing to the fact that the housing shell is upwardly open in said arm rest position of the rest body and accordingly is accessible from above, it is also possible to deposit at least one drinking vessel in the housing shell. The housing shell including the collar is preferably produced from a thermoplastic material.

In a refinement of the invention, the rest body is designed as a foam body. The foam body is produced from an elastically flexible plastics foam material with a high pore density. The receptacle for the housing shell is formed in the foam body. The foam body serves in a leaning position of the rest body as padding in order also to continue a padding function of the backrest arrangement in the region of the pivotable rest arrangement.

In a further refinement of the invention, a supporting frame is provided which is surrounded by the rest body, and which is assigned a pivot mounting which is connectable to vehicle-side pivot receptacles. The supporting frame is produced from metal and preferably has longitudinal and crossmembers which are connected to a pivot spindle. The pivot spindle is preferably provided with bearing bolt portions which form the pivot mounting of the rest arrangement.

In a further refinement of the invention, at least one latching clip is integrally formed on an outer side of the housing shell and is connectable to a mating portion of the supporting frame in a form-fitting manner. Preferably, two latching clips are integrally formed on opposite end sides of the housing shell and protrude outward from an outer wall of the housing shell. The latching clips are preferably designed as omega clips which have a substantially Q-shaped cross section which is opened toward a lower side. The at least one latching clip can be plugged and latched onto a crossmember of the supporting frame from above, wherein a cross section of the crossmember is preferably designed in a complementary manner to a free cross section of the latching clip. The at least one latching clip is designed in an advantageous manner such that it can also be released again from the mating portion of the support frame, in particular from the crossmember, after being latched thereon.

In a further refinement of the invention, the collar is provided in the region of its lower side with downwardly protruding plug-in pins which penetrate the cover in the region of the edge of the receptacle and which enter the foam body in a form-fitting manner. This firstly results in the cover being clamped on the foam body. Secondly, both the cover and the collar are fixed relative to the foam body. Accordingly, the plug-in pins have a dual function since they firstly secure the cover in the region of an edge of the receptacle of the foam body and since they secondly ensure positional securing of the collar and therefore preferably also of the housing shell relative to the foam body.

In a further refinement of the invention, the plug-in pins are formed integrally on the collar. In this refinement, the plug-in pins are produced together with the collar of the housing shell by being produced in particular from the same plastics material as the collar in a single-stage injection molding operation. In the injection molding operation, the plug-in pins are integrally formed on the collar, preferably with the simultaneous production of the housing shell if the latter integrally surrounds the collar.

In a further refinement of the invention, the foam body is provided in the region of the edge of the receptacle with an encircling clamping frame which is held in the foam body and is covered by the cover, and the collar of the housing shell is connected to the clamping frame and covers the cover in the region of the edge of the receptacle. The clamping frame ensures that the housing shell is secured in the mounted state in the receptacle of the foam body. In addition, the cover is held with an edge region of a recess of the cover surrounding the receptacle between the collar and the clamping frame in the manner of a sandwich.

In a further refinement of the invention, the cover is clamped between the collar and the clamping frame. This achieves a force-fitting securing of the edge region of the recess of the cover in the region of the receptacle.

In a further refinement of the invention, the clamping frame has passages for plug-in pins of the collar, and the plug-in pins penetrate the cover located between the clamping frame and the collar. The cover located between the clamping frame and the collar defines an encircling edge region of a recess of the cover, said recess being coordinated with an area of the receptacle of the foam body.

In a further refinement of the invention, the clamping frame is provided with mounting claws which are each integrally formed on the clamping frame by means of a film hinge and are arranged pivotably between a starting position protruding toward a center from the clamping frame and a functional position in which said mounting claws grip into a wall of the receptacle of the foam body. A fixed body joint of any type can be considered as the film hinge. The refinement permits an inevitable anchoring of the mounting claws of the clamping frame in the wall of the receptacle of the foam body as soon as the housing shell is inserted into the clamping frame from above.

In a further refinement of the invention, the housing shell is provided with latching and/or plug-in profilings which interact with complementary latching and/or plug-in profilings of the mounting claws and/or of the clamping frame in order to fix the housing shell in its state inserted into the receptacle of the foam body.

In a further refinement of the invention, the housing shell is divided into a housing upper part having the collar and into a housing lower part, wherein the housing lower part is embedded in the foam body and the housing upper part is connected to the cover by the collar being connected in an encircling manner to an edge of the cover in the region of a recess for the receptacle. The housing lower part is fixed in the receptacle of the foam body. The housing upper part is fixedly connected to the cover, and therefore, when the cover is pulled onto the foam body, securing and clamping of the cover can be inevitably achieved by means of a connection of the housing upper part to the housing lower part.

In a further refinement of the invention, the housing upper part and the housing lower part are connected to each other in an integrally bonded manner, in particular by adhesive bonding. Instead of adhesive bonding, an integrally bonded connection can also be achieved by means of welding, in particular ultrasonic welding.

For the method of the type mentioned at the beginning, wherein a foam body is provided with a receptacle for a housing shell, and wherein the foam body is provided with a cover, the object on which the invention is based is achieved in that a collar of the housing shell is connected to the cover in an edge region of the receptacle. In addition, fixing of the housing shell in the receptacle, in particular by a force fit or by an integrally bonded connection, preferably in the form of adhesive bonding, is achieved with the method according to the invention.

In a refinement of the method, plug-in pins are integrally formed on the collar, said plug-in pins penetrating the cover and entering the foam body when the housing shell is inserted into the receptacle. The plug-in pins penetrate the edge region of the recess of the cover in the region of the receptacle.

In a further refinement of the invention, a clamping frame is molded into the foam body in the region of the receptacle, and, when the housing shell is inserted into the receptacle, the collar of the housing shell is connected to the clamping frame, with the fitting of an encircling edge of the cover in-between. As a result, when the housing shell is inserted, an inevitable connection to the edge region of the recess of the cover is produced. The clamping frame is preferably placed into a plastics foaming mold in which the foam body is produced, and therefore molding of the clamping frame inevitably arises during foaming of the foam body.

In a further refinement of the invention, mounting claws are integrally formed on the clamping frame, said mounting claws in a starting state protruding freely toward a center of the receptacle, and, when the housing shell is inserted into the receptacle, said mounting claws being pressed downward and outward, as a result of which the mounting claws penetrate walls of the receptacle of the foam body. This permits a particularly simple production of the rest arrangement since, with the insertion of the housing shell from above, firstly the securing of the housing shell relative to the clamping frame and secondly the fixing and clamping of the edge region of the cover between the collar of the housing shell and the clamping frame are inevitably achieved.

In a further refinement of the method, the housing shell latches on the outer side with the mounting claws as soon as the housing shell has reached its functional position inserted into the receptacle. Alternatively or additionally to latching of the housing shell with the mounting claws, latching of the housing shell with the clamping frame is preferably also provided.

In a further refinement of the invention, the housing shell is produced as two separate components in the form of a housing upper part having the collar and in the form of a tub-shaped housing lower part, the housing lower part is subsequently embedded into the receptacle of the foam body, the housing upper part is connected to the cover, and the cover is pulled onto the foam body, with the housing upper part being connected in the region of the receptacle to an upper edge of the housing lower part. The housing upper part is connected to an upper edge of the housing lower part preferably by adhesive bonding. The housing upper part and the housing lower part either butt against each other or overlap each other. The respective contact surface is provided with a suitable adhesive film, thus resulting in the desired adhesive bonding. The housing upper part is connected to the edge region of the cover around the recess of the cover.

Further advantages and features of the invention emerge from the clams and from the description below of preferred exemplary embodiments of the invention which are illustrated with reference to the drawings.

### BRIEF DESCRIPTION OF THE DRAWINGS

FIG. 1 shows, in an exploded illustration, a first embodiment of a pivotable rest arrangement according to the invention,

FIG. 2 shows, in a perspective illustration, a partial region of the rest arrangement according to FIG. 1 without rest body and cover,

FIG. 3 shows a longitudinal section through the rest arrangement according to FIG. 1,

FIG. 4 shows an enlarged detail IV of the illustration according to FIG. 3,

FIG. 5 shows a cross section through the rest arrangement according to FIGS. 1 to 3,

FIG. 6 shows an enlarged detail VI of the illustration according to FIG. 5,

FIG. 7 shows a further embodiment of a pivotable rest arrangement according to the invention in an exploded illustration,

FIGS. 8a to 8c show schematically, in a detail, various mounting steps of the rest arrangement according to FIG. 7,

FIG. 9 shows a further embodiment of a pivotable rest arrangement according to the invention in an exploded illustration,

FIG. 10 shows, in a perspective illustration obliquely from below, a clamping frame and a housing shell of the rest arrangement according to FIG. 9,

FIG. 11 shows, in an exploded illustration, a cover and a rest body according to a further embodiment of a pivotable rest arrangement according to the invention, and

FIG. 12 shows, in a full exploded illustration, the rest arrangement according to FIG. 11.

### DETAILED DESCRIPTION

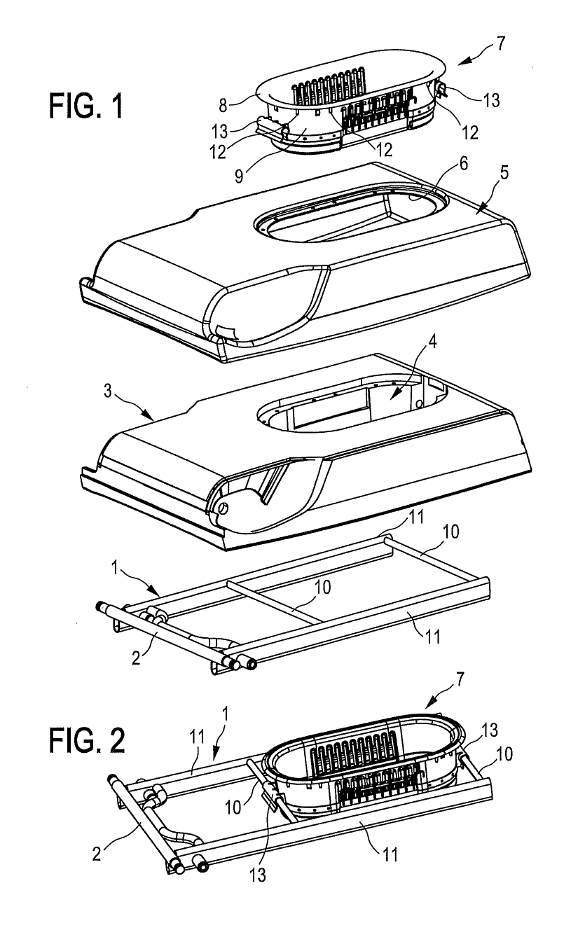

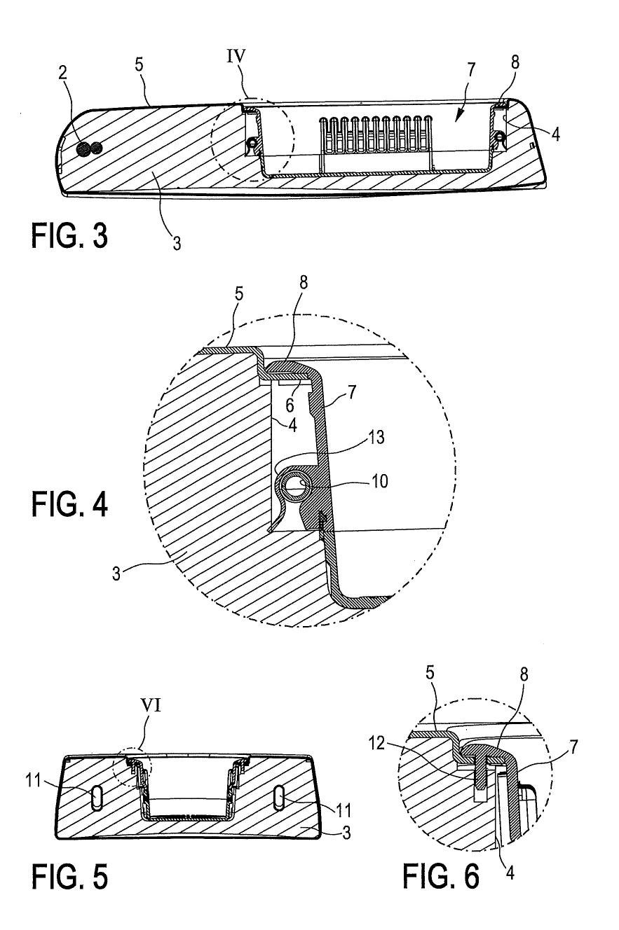

A passenger vehicle has, as illustrated with reference to FIGS. 1 and 2 in DE 10 2013 204 000 A1, in a vehicle interior a rear seat bench which is provided with a pivotable rest arrangement in the region of a center of the vehicle. As an alternative to the rest arrangement according to DE 10 2013 204 000 A1, the rest arrangements which are illustrated with reference to FIGS. 1 to 12 and are described in more detail below are insertable into a corresponding recess of a backrest arrangement of the rear seat bench and are mounted pivotably between a leaning position recessed into the recess of the backrest arrangement and a functional position which is oriented approximately horizontally forward and downward. In the mounted state of the rest arrangement according to the invention according to one of the embodiments according to FIGS. 1 to 12, the corresponding rest arrangement is held mounted on the vehicle in the region of the backrest arrangement of the rear seat bench, wherein a pivot spindle of the rest arrangement extends in the transverse direction of the vehicle. In all of the embodiments according to FIGS. 1 to 12, the pivot spindle is formed by a crossmember 2, 2a, 2b, 2c of a supporting frame 1, 1a, 1b, 1c, which crossmember is provided on its opposite front ends with pivot bearing bolts which are not denoted specifically and are also referred to as bearing bolt portions. The pivot bearing bolts interact with corresponding, vehicle-mounted counter bearings in the region of the rear seat bench as soon as the rest arrangement is mounted on the vehicle side. The supporting frame 1, 1a, 1b, 1c of each rest arrangement according to FIGS. 1 to 12 in each case has two longitudinal members 11 which are spaced apart parallel to each other and are connected to each other via the crossmember forming the respective pivot spindle 2, 2a, 2b, 2c. The supporting frame is composed of metal.

In addition, a common feature of all of the embodiments according to FIGS. 1 to 12 is that, in addition to a supporting frame 1, 1a, 1b, 1c and a pivot spindle 2, 2a, 2b, 2c assigned to the supporting frame 1, 1a, 1b, 1c, a rest body in the form of a foam body 3, 3a, 3b, 3c and a cover 5, 5a, 5b, 5c composed of a textile, flexible surface material are provided in each case. In addition, integrated in each foam body 3, 3a, 3b, 3c is a receptacle 4, 4a, 4b, 4c into which a single- or multi-part housing shell 7, 7a, 7b, 7c is insertable, the housing shell serving for receiving and holding one or two drinking vessels. The respective housing shell 7, 7a, 7b, 7c is composed of a thermoplastic and is preferably produced in an injection molding process. The respective foam body 3, 3a, 3b, 3c is integrally produced from an elastically flexible plastics foam material which carries out elastically flexible padding functions, in particular in the leaning position of the rest arrangement. In all of the embodiments, the respective supporting frame 1, 1a, 1b, 1c is integrated in the foam body 3. This is achieved by introducing the supporting frame 1, 1a, 1b, 1c into the tool mold for producing the foam body 3, 3a, 3b, 3c. The respective pivot spindle 2, 2a, 2b, 2c is encapsulated by the foam body 3 by foaming in such a manner that the opposite pivot bearing bolts project out of the foam body 3 on opposite sides.

The cover 5, 5a, 5b, 5c is coordinated with the three-dimensional geometrical shape of the foam body 3 and is pulled onto the foam body 3 and fixed thereon.

In addition, a common feature of all of the embodiments is that the respective housing shell 7, 7a, 7b, 7c is fixed, i.e. positionally secured, both in the respective receptacle 4, 4a, 4b, 4c of the respective foam body 3, 3a, 3b, 3c and is also fixedly connected to the respective cover 5, 5a, 5b, 5c, with the cover 5, 5a to 5c being clamped in an edge region of a recess 6, 6a, 6b, 6c of the cover 5, wherein the edge region is designed in an annularly encircling manner. The recess 6, 6a, 6b, 6c is coordinated with an edge contour of the respective receptacle 4, 4a, 4b, 4c of the foam body 3, 3a, 3b, 3c in the region of its upper side. In addition, each housing shell 7, 7a, 7b, 7c has, in the region of its upper side, an encircling collar 8, 8a, 8b, 8c which, in the mounted state of the housing shell 7, 7a, 7b, 7c, is positioned from an upper side on the edge region of the recess 6, 6a to 6c of the cover 5, 5a to 5c and presses the cover against the edge contour of the receptacle 4, 4a, 4b, 4c of the foam body 3, 3a, 3b, 3c.

The various embodiments according to FIGS. 1 to 12 will be described in detail below:

The pivotable rest arrangement according to FIGS. 1 to 6 has a supporting frame 1, wherein the two longitudinal members 11 are connected to each other by two crossmembers 10 spaced apart parallel to each other. The one crossmember 10 is positioned on a front end region of the longitudinal members 11 lying opposite the pivot spindle 2 and is fixedly connected to the longitudinal members 11. The other longitudinal member 10 is positioned at a distance from the end-side longitudinal member 10 and is connected fixedly to the longitudinal members 11, said distance at least substantially corresponding to a length of the housing shell 7. The two crossmembers 10 are of cylindrical design. The housing shell 7 has, on opposite end sides at a distance below the collar 8, respective latching clips 13 which are designed as omega clips. The latching clips 13 are formed integrally on the outer side of the end sides of an encircling wall of the housing shell 7. The latching clips 13 have a tubular or groove cross section which extends in the transverse direction of the support frame 1 and which is in each case open downward. The two latching clips 13 define an omega-shaped cross section. The two latching clips 13 are provided to be latched together with the housing shell 7 on the two crossmembers 10 of the supporting frame 1 (FIGS. 2 and 4).

The collar 8 of the housing shell 7 protrudes outward laterally from an upper edge of the encircling wall of the housing shell 7 and is formed integrally with the wall. From a lower side of the collar 8, a plurality of plug-in pins 12 which are arranged distributed over the circumference of the collar 8 protrude downward and, when the housing shell 7 is inserted, penetrate corresponding holes in the edge region of the recess 6 of the cover 5 and are pressed into an upper annular shoulder of the edge contour of the receptacle 4 of the foam body 3. As a result, when the housing shell 7 is inserted into the receptacle 4 of the foam body 3, the edge region of the recess 6 of the cover 5 is inevitably pulled downward at the same time and pressed against the annular shoulder of the edge region of the receptacle 4. By this means, the cover 5 is clamped and fixed relative to the receptacle 4. In addition, the latching clips 13 latch on the crossmembers 10, as a result of which the housing shell 7 is fixed relative to the supporting frame 1 and therefore also relative to the foam body 3. Accordingly, the rest arrangement according to FIGS. 1 to 6 is fittable without a tool, by fixing the housing shell 7 in the foam body 3 and by simultaneous clamping and wedging of the cover 5, in particular in the edge region of the recess 6, relative to the foam body 3.

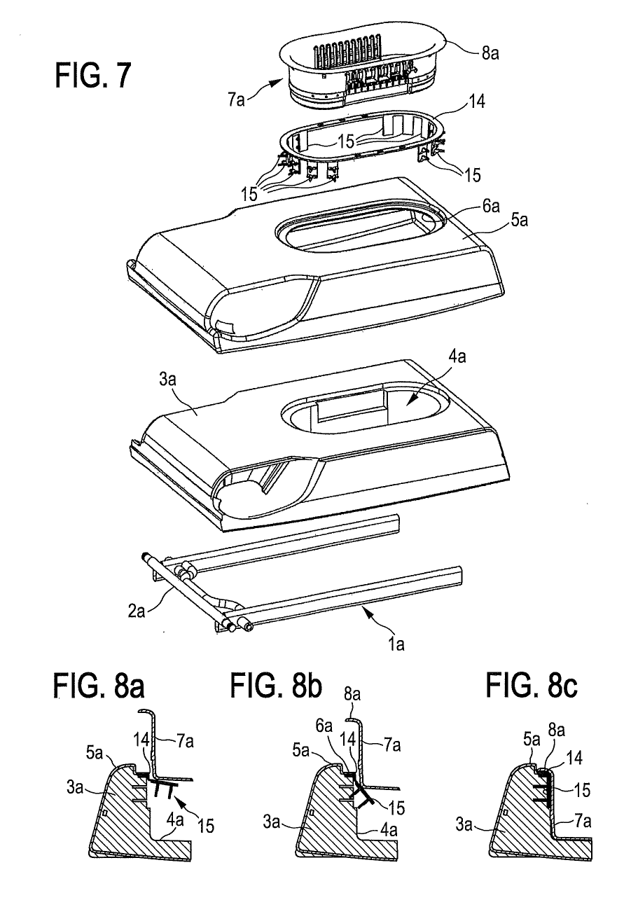

In the embodiment of a pivotable rest arrangement according to FIGS. 7 and 8a to 8c, the housing shell 7a is fixed relative to a clamping frame 14 which is positioned in the region of the annular shoulder of the edge contour of the receptacle 4a of the foam body 3a and is molded into the foam body 3a during the production thereof. The clamping frame 14 is designed annularly in the manner of an oval and has a plurality of mounting claws 15 which are arranged distributed over its circumference and protrude approximately horizontally toward a center of the receptacle 4 before the housing shell 7a is inserted (see FIG. 8a). The respective mounting claw 15 is integrally formed on the clamping frame 14, which is produced from a thermoplastic, wherein the respective mounting claw 15 is connected to the clamping frame 14 by means of a film hinge. The film hinge defines a pivot joint for the respective mounting claw 15. The mounting claw 15 has claw studs which protrude downward or outward and, when the respective mounting claw is pivoted downward from its horizontal starting position, inevitably press into a wall of the receptacle 4a of the foam body 3a (see FIGS. 8b and 8c). It can be seen with reference to FIGS. 8a to 8c that the edge region of the recess 6a of the cover 5a is positioned above the clamping frame 14 before the housing shell 7a is inserted from above into the receptacle 4a. When the housing shell 7a is inserted into the receptacle 4a, a base of the housing shell 7a inevitably presses the mounting claws 15 downward and outward into the wall of the receptacle 4a. In addition, a lower side of the collar 8a of the housing shell 7a presses the edge region of the cover 5a onto the clamping frame 14 from above, as a result of which the edge region of the cover 5a is wedged. The housing shell 7a is additionally provided in the region of its outer side with latching profilings which secure the housing shell 7a relative to the mounting claws 15 and relative to the clamping frame 14 in the inserted final position. It is thereby ensured that the housing shell 7a cannot be detached again upward from the receptacle 4a in a driving mode of the passenger vehicle.

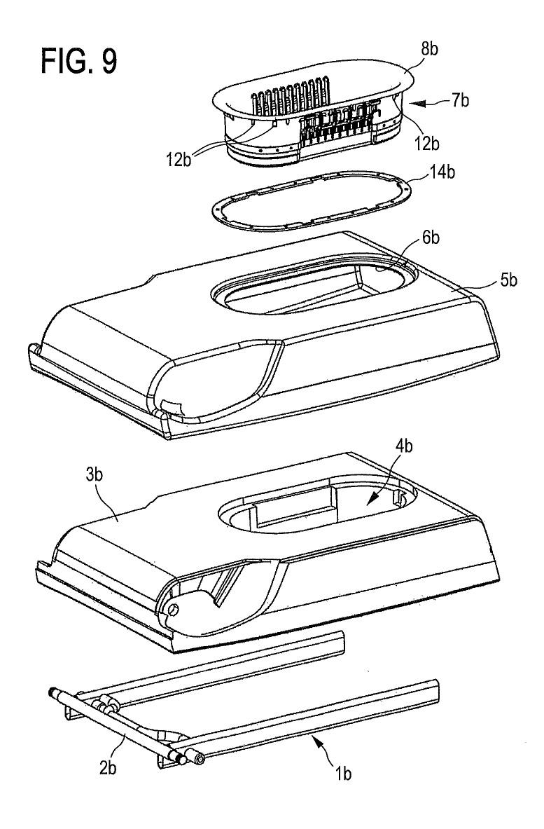

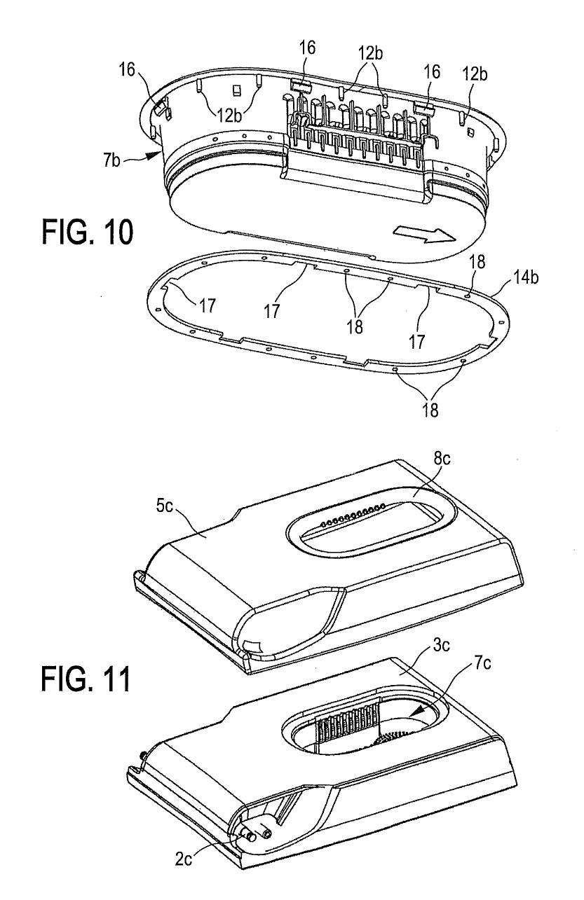

In the embodiment according to FIGS. 9 and 10, an annular clamping frame 14b is likewise molded into the foam body 3b in the region of an annular shoulder of an edge contour of the receptacle 4b and thus fixed to in the foam body 3b. The clamping frame 14b has latching profilings 17 and plug-in profilings 18, wherein the latching profilings 17 are configured as latching recesses and the plug-in profilings as circular plug-in passages. The housing shell 7b has, on its outer side directly below the collar 8b, a plurality of complementary latching profilings 16 which are designed as latching lugs. In addition, the collar 8b has plug-in pins 12b which protrude downward from a lower side of the collar 8b and are designed as complementary plug-in profilings to the plug-in passages of the clamping frame 14b.

For the completion of the rest arrangement, the cover 5b is pulled onto the foam body 3b in such a manner that an encircling edge region of the recess 6b of the cover 5b is positioned above the clamping frame. The housing shell 7b is subsequently inserted into the receptacle 4b from above, as a result of which the plug-in pins 12b in the region of the lower side of the collar 8b inevitably penetrate the edge region of the cover 5b and press the edge region of the cover 5b against the clamping frame 14b. Accordingly, the edge region of the cover 5b is firstly wedged between the clamping frame 14b and the collar 8b. Secondly, the edge region is additionally also fixed in a form-fitting manner relative to the clamping frame 14b and therefore relative to the foam body 3b by the plug-in pins 12b which penetrate the edge region and enter the plug-in profilings 18 of the clamping frame 14b and subsequently penetrate the foam body.

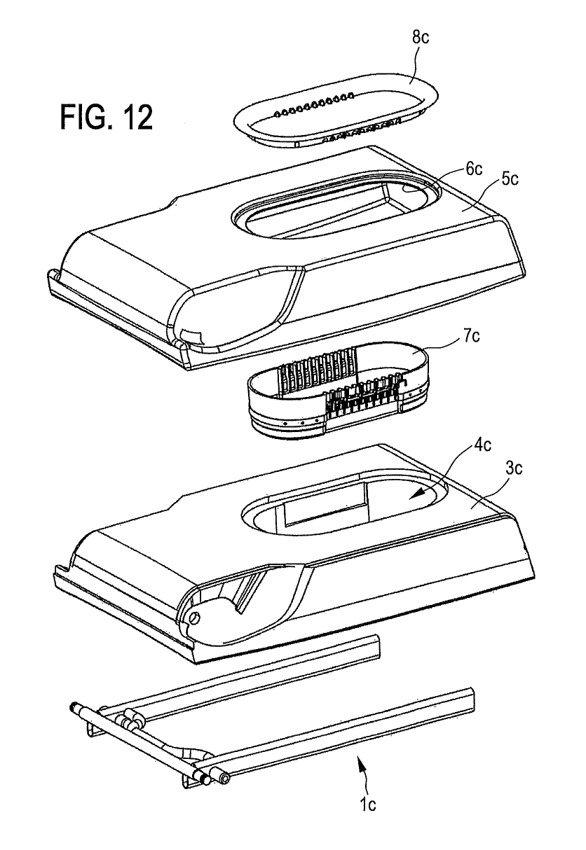

In, the embodiment according to FIGS. 11 and 12, the housing shell of the rest arrangement is divided into a housing upper part having the collar 8c and into a tub-shaped housing lower part. For the mounting of the rest arrangement, the housing lower part 7c is inserted into the receptacle 4c and fixed there in an integrally bonded or force-fitting manner. The housing upper part with the collar 8c is adhesively bonded to the edge region of the recess 6c of the cover 5c, wherein the collar 8c rests on an upper side of the edge region of the recess 6c. The cover 5c is subsequently pulled onto the foam body 3c, as a result of which the housing upper part is inevitably aligned with the collar 8c and positioned directly above an upper edge of the housing lower part 7c. A lower edge of the housing upper part with the collar 8c and the upper edge of the housing lower part 7c butt against each other in an encircling manner. The corresponding contact surfaces are provided with an adhesive layer, as a result of which the housing upper part and the housing lower part are adhesively bonded to each other and are accordingly fixed against each other.

1. A pivotable rest arrangement for a vehicle interior, with a rest body which has a cover and a receptacle for a housing shell which is configured for holding at least one drinking vessel, the housing shell having an encircling collar, wherein the collar in the mounted state covers the cover in the region of an edge of the receptacle, and wherein the collar is connected to the cover in a form-fitting, integrally bonded or force-fitting manner.

2. The pivotable rest arrangement as claimed in claim 1, wherein the rest body is designed as a foam body.

3. The pivotable rest arrangement as claimed in claim 1, wherein a supporting frame is provided which is surrounded by the rest body, and which is assigned a pivot mounting which is connectable to vehicle-side pivot receptacles.

4. The pivotable rest arrangement as claimed in claim 1, wherein at least one latching clip is integrally formed on an outer side of the housing shell and is connectable to a mating portion of the supporting frame in a form-fitting manner.

5. The pivotable rest arrangement as claimed in claim 1, wherein the collar is provided in the region of its lower side with downwardly protruding plug-in pins which penetrate the cover in the region of the edge of the receptacle and which enter the foam body in a form-fitting manner.

6. The pivotable rest arrangement as claimed in claim 5, wherein the plug-in pins are integrally formed on the collar.

7. The pivotable rest arrangement as claimed in claim 1, wherein the foam body is provided in the region of the edge of the receptacle with an encircling clamping frame which is held in the foam body and is covered by the cover, and wherein the collar of the housing shell is connected to the clamping frame and covers the cover in the region of the edge of the receptacle.

8. The pivotable rest arrangement as claimed in claim 7, wherein the cover is clamped between the collar and the clamping frame.

9. The pivotable rest arrangement as claimed in claim 7, wherein the clamping frame has passages for plug-in pins of the collar, and wherein the plug-in pins penetrate the cover located between the clamping frame and the collar.

10. The pivotable rest arrangement as claimed in claim 7, wherein the clamping frame is provided with mounting claws which are each integrally formed on the clamping frame by means of a film hinge and are arranged pivotably between a starting position protruding toward a center from the clamping frame and a functional position in which said mounting claws grip into a wall of the receptacle of the foam body.

11. The pivotable rest arrangement as claimed in claim 7, wherein the housing shell is provided with latching and/or plug-in profilings which interact with complementary latching and/or plug-in profilings of the mounting claws and/or of the clamping frame in order to fix the housing shell in its state inserted into the receptacle of the foam body.

12. The pivotable rest arrangement as claimed in claim 1, wherein the housing shell is divided into a housing upper part having the collar and into a housing lower part, wherein the housing lower part is embedded in the foam body and the housing upper part is connected to the cover by the collar being connected in an encircling manner to an edge of the cover in the region of a recess for the receptacle.

13. The pivotable rest arrangement as claimed in claim 12, wherein the housing upper part and the housing lower part are connected to each other in an integrally bonded manner, in particular by adhesive bonding.

14. A method for producing a pivotable rest arrangement as claimed in claim 1, a foam body being provided with a receptacle for a housing shell, and the foam body being provided with a cover, wherein a collar of the housing shell is connected to the cover in an edge region of the receptacle.

15. The method as claimed in claim 14, wherein plug-in pins are integrally formed on the collar, said plug-in pins penetrating the cover and entering the foam body when the housing shell is inserted into the receptacle.

16. The method as claimed in claim 14, wherein a clamping frame is molded into the foam body in the region of the receptacle, and wherein, when the housing shell is inserted into the receptacle, the collar of the housing shell is connected to the clamping frame, with the fitting of an encircling edge of a recess of the cover in between.

17. The method as claimed in claim 16, wherein mounting claws are integrally formed on the clamping frame, said mounting claws in a starting state protruding freely toward a center of the receptacle, and, when the housing shell is inserted into the receptacle, said mounting claws being pressed downward and outward, as a result of which the mounting claws penetrate walls of the receptacle of the foam body.

18. The method as claimed in claim 17, wherein the housing shell latches on the outer side with the mounting claws and/or the clamping frame as soon as the housing shell has reached its functional position inserted into the receptacle.

19. The method as claimed in claim 14, wherein the housing shell is produced as two separate components in the form of a housing upper part having the collar and in the form of a tub-shaped housing lower part, wherein the housing lower part is subsequently embedded into the receptacle of the foam body, wherein the housing upper part is connected to the cover, and wherein the cover is attached to the foam body, with the housing upper part being connected, in particular adhesively bonded, in the region of the receptacle to an upper edge of the housing lower part.
